(19) United States
(12) Patent Application Publication
(10) Pub. No.: US 2026/0186488 A1
(43) Pub. Date: Jul. 2, 2026

(54) ROBOT CONTROL BASED ON NATURAL LANGUAGE (NL) INPUT AND BASED ON DESCRIPTOR(S) OF OBJECT(S) THAT ARE PRESENT IN ENVIRONMENT WITH ROBOT AND RELEVANT TO THE NL INPUT

(71) Applicant: GDM Holding LLC, Mountain View, CA (US)

(72) Inventors: Boyuan Chen, Cambridge, MA (US); Daniel Kappler, San Francisco, CA (US); Fei Xia, Sunnyvale, CA (US)

(21) Appl. No.: 19/112,153

(22) PCT Filed: Sep. 14, 2023
(86) PCT No.: PCT/US2023/032714

§ 371 Date: Mar. 14, 2025

Related U.S. Application Data
(60) Provisional application No. 63/407,019, filed on Sep. 15, 2022.

(51) Int. Cl. G05D 1/2285; G05D 1/246; G05D 1/648; G05D 109/10; G05D 111/10; G06T 7/70; G06V 10/25; G06V 20/70

(52) U.S. Cl. CPC G05D 1/2285; G05D 1/246; G05D 1/648; G06T 7/70; G06V 10/25; G06V 20/70; G05D 2109/10; G05D 2111/10; G06T 2207/30244

(57) ABSTRACT

Some implementations relate to generating, based on processing captured vision data instances throughout an environment: regions of interest, and an estimated map location and region embedding(s) for each region of interest. Some implementations additionally or alternatively relate to determining, based on (1) a free form (FF) natural language (NL) instruction for a robot to perform a task and (2) generated region embedding(s) for identified regions of interest in an environment: object descriptors that describe objects that are relevant to performing the task and that are likely present in the environment. Some implementations additionally or alternatively relate to utilizing a subset of object descriptor(s), determined to be descriptive of object(s) that are relevant to performing the task of an FF NL instruction and likely included in the environment, in determining robotic skill(s) for robot(s) to implement in performing the task specified in the FF NL instruction.

### BACKGROUND

Many robots are programmed to perform certain tasks. For example, a robot on an assembly line can be programmed to recognize certain objects, and perform particular manipulations to those certain objects.

Further, some robots can perform certain tasks in response to explicit user interface input that corresponds to the certain task. For example, a vacuuming robot can perform a general vacuuming task in response to a spoken utterance of “robot, clean”. However, often, user interface inputs that cause a robot to perform a certain task must be mapped explicitly to the task. Accordingly, a robot can be unable to perform certain tasks in response to various free-form natural language inputs of a user attempting to control the robot.

### SUMMARY

Efforts have been made in attempting to enable robust free-form (FF) natural language (NL) control of robot. For example, to enable a robot to react appropriately in response to any one of a variety of different typed or spoken instructions from a human that are directed to the robot. For instance, in response to FF NL instructions of “put the purple unicorn plush toy in the toy bin”, to be able to perform a robotic task that includes (a) navigating to the “purple unicorn plush”, (b) picking up the “purple unicorn plush” (a toy), (c) navigating to the “toy bin”, and (d) placing the “purple unicorn plush” in the “toy bin”.

However, for various FF NL instructions, various techniques can fail in determining and/or implementing steps of a robotic task-and/or can present robotic inefficiencies in implementing step(s) of the task and/or robotic and/or other computational inefficiencies in determining step(s) of the task.

For example, some techniques are only able to perform task(s) that involve object(s) that are currently observable by the robot (e.g., in line(s) of sight of vision component(s) of the robot). For instance, those techniques would fail for “put the purple unicorn plush in the toy bin” if the “purple unicorn plush” and/or the “toy bin” were not currently observable by the robot. As another example, some techniques may store a representation of an object that was previously detected and is currently not observable by the robot. However, such representation is often stored as one of multiple constrained predefined categories, resulting in failure of identifying a “purple unicorn plush” due to, for example, the representation of the corresponding object only being stored in association with a disparate representation. As yet another example, some techniques may enable, responsive to FF NL instructions, exploration in an attempt to locate relevant object(s). However, such reactive exploration delays performance of the corresponding task. Further, in situations where relevant object(s) are not present (or not locatable) in the environment, such exploration is needlessly performed, resulting in waste of robot resources.

In view of these and/or other considerations, some implementations disclosed herein are directed to generation and utilization of an open-vocabulary and queryable scene representation to facilitate language model based robotic task planning and implementation of the planned task. The scene representation is queryable with an open vocabulary, which prevents having to limit the objects involved in robotic task planning to a closed set. Some of those implementations parse a free-form (FF) natural language (NL) instruction, provided by a human, and determine object descriptor(s) that are relevant to the FF NL instruction. Such object descriptor(s) can include descriptor(s) that are explicitly included in the FF NL instruction and/or descriptor(s) that are inferred from, but not explicitly included in, the FF NL instruction. The object descriptor(s) (e.g. text embeddings thereof) can then be used to query an environment map (e.g., represented as region embeddings, of regions of interest, and their associated estimated map locations) to determine which object descriptor(s) correspond to object(s) that are present in the environment and to determine location(s) of those corresponding object(s). The object descriptor(s), that are determined to correspond to object(s) that are present in the environment, and location(s) of at least some of those corresponding object(s), can then be used in robotic task planning and implementation of the planned task. For example, a large language model (LLM) can be utilized for the planning, and the determined object descriptor(s) can be processed, using the LLM and along with the FF NL instruction, to determine robotic skill(s) to implement to accomplish the task specified by the FF NL instruction. Utilization of the determined object descriptor(s) improves robustness and/or accuracy of the determined robotic skill(s). Further, the querying and utilization of the environment map enables consideration and use, in planning, of object(s) that may not be observable by a robot at the time of the FF NL command and/or that may not be specified in the FF NL command. Yet further, the querying and utilization of the environment map enables robust and accurate robotic task performance without requiring the FF NL command to conform to any particular object classification syntax.

Some implementations disclosed herein relate to generating, based on processing captured vision data instances throughout an environment: regions of interest, and an estimated map location and region embedding(s) for each region of interest. Those implementations further store, for later utilization, at least the estimated location and the region embedding(s) for each region of interest and in association with one another. For example, each captured vision data instance can be processed, using a class-agnostic object detection model, in detecting region(s) of interest in the vision data instance, if any. Further, for each detected region: (1) an estimated map location of the detected region can be determined and (2) region embedding(s), for that region, can be generated based on processing vision data, from the vision data instance, that is within the region of interest. For instance, pixels within the region of interest can be processed using a visual language model (VLM) encoder to generate a region embedding. Optionally, multiple region embeddings are generated for each region of interest, and each is generated using a different VLM encoder.

This enables utilization of the multiple region embeddings in other techniques disclosed herein, which be beneficial as some type(s) of embeddings are more robust for certain type(s) of objects (e.g., out of distribution objects) and other type(s) of embeddings are more robust for certain other type(s) of objects (e.g., common objects).

Some implementations disclosed herein additionally or alternatively relate to determining, based on (1) a FF NL instruction for a robot to perform a task and (2) generated region embedding(s) for identified regions of interest in an environment: object descriptors that describe objects that are relevant to performing the task and that are likely present in the environment. For example, a superset of candidate object descriptors can be determined, based on the FF NL instruction, that each describes an object that is relevant to performing the task. For instance, object descriptor(s) that are explicitly present in the FF NL instruction can be determined and/or object descriptor(s) that are not explicitly present in, but derivable from, the FF NL instruction can be determined. Further, text embeddings, for the object descriptors, can be compared to region embeddings for the regions of interest. The comparison of a text embedding to a region embedding can produce a measure that indicates likelihood that the text (corresponding to the text embedding) is descriptive of a region of interest (corresponding to the region embedding). Any object descriptors, whose text embedding is close to any (or at least a threshold quantity of) the region embeddings, can be included in a subset of the superset of object descriptors.

Accordingly, the determined subset of object descriptors are descriptive of object(s) that: (a) are relevant to performing the task of the FF NL instruction and (b) are likely included in the environment (as indicated by the text embedding(s) of their corresponding object descriptor(s) being close to region embedding(s)). In these and other manners, implementations enable determination, efficiently and with low latency, of object descriptors that describe objects that are both relevant to performing a task of an FF NL instruction and likely present in the environment. Further, previously generated region embeddings, for regions of interest, can be utilized in such a determination-preventing the need for on-demand exploration to identify object(s) that are both relevant to performing a task of an FF NL instruction and are likely present in the environment. Yet further, comparing text embeddings and region embeddings and/or other techniques described herein enable identification of object(s) in the environment that are relevant to an FF NL instruction, without the FF NL instruction needing to conform to any object classification grammar.

Some implementations disclosed herein additionally or alternatively relate to utilizing a subset of object descriptor(s), determined to be descriptive of object(s) that are relevant to performing the task of an FF NL instruction and likely included in the environment, in determining robotic skill(s) for robot(s) to implement in performing the task specified in the FF NL instruction. For example, the subset can be utilized, optionally without other object descriptor(s), in determining robotic skill(s) for robot(s) to implement in performing the task.

This can prevent wastefully considering robotic skill(s) that are specific to object(s) that do not correspond to the object descriptor(s) of the subset and/or wasteful erroneous selection (and implementation) of such robotic skills. In some implementations, utilizing the determined subset of object descriptor(s) in determining robotic skill(s) for robot(s) to implement in performing the task, includes generating instances of LLM output based on processing the determined object descriptors, and the FF NL instructions, using an LLM. In some of those implementations, the instance(s) of LLM output are used in determining robotic skills for robot(s), in the environment, to implement in performing the task.

The above description is provided as an overview of only some implementations disclosed herein. These and other implementations are described in more detail herein, including in the detailed description and the claims.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A illustrates an example of a human providing a free-form (FF) natural language (NL) instruction to an example robot.

FIG. 1B1 illustrates a simplified birds-eye view of an example environment in which the human and the robot of FIG. 1A are located, and illustrates an example vision data instance previously captured in the environment.

FIG. 1B2 illustrates the birds-eye view of FIG. 1B1, and illustrates locations, of previously determined regions of interest, determined to be relevant to a corresponding object descriptor describing an object relevant to a task of the FF NL instruction of FIG. 1A.

FIG. 2 is a flowchart illustrating an example method of controlling a robot, based on FF NL input and based on descriptor(s) of objects that are present in an environment with the robot and relevant to the FF NL input, according to implementations disclosed herein.

FIG. 3 is a flowchart illustrating implementations of block 300 of the method of FIG. 2.

FIG. 4 is a flowchart illustrating implementations of block 400 of the method of FIG. 2.

FIG. 5 is a flowchart illustrating implementations of block 500 of the method of FIG. 2.

FIG. 6 schematically depicts an example architecture of a robot.

FIG. 7 schematically depicts an example architecture of a computer system.

### DETAILED DESCRIPTION

Some implementations disclosed herein generate open-vocabulary and queryable scene representation to facilitate language model based robotic task planning and implementation of the planned task. The scene representation is queryable with an open vocabulary, which prevents having to limit the objects involved in robotic task planning to a closed set. Some of those implementations utilize a natural language-based object proposal module to parse free-form (FF) natural language (NL) instruction, provided by a human, and determine object descriptor(s) that are relevant to the FF NL instruction. Such object descriptor(s) can include descriptor(s) that are explicitly included in the FF NL instruction and/or descriptor(s) that are inferred from, but not explicitly included in, the FF NL instruction. The object descriptor(s) (e.g. text embeddings thereof) can then be used to query an environment map (e.g., represented as region embeddings, of regions of interest, and their associated estimated map locations) to determine which object descriptor(s) correspond to object(s) that are present in the environment and to determine location(s) of those corresponding object(s). The object descriptor(s), that are determined to correspond to object(s) that are present in the environment, and location(s) of at least some of those corresponding object(s), can then be used in robotic task planning and implementation of the planned task. For example, a large language model (LLM) can be utilized for the planning, and the determined object descriptor(s) can be processed, using the LLM and along with the FF NL instruction, to determine robotic skill(s) to implement to accomplish the task specified by the FF NL instruction. Utilization of the determined object descriptor(s) improves robustness and/or accuracy of the determined robotic skill(s). Further, the querying and utilization of the environment map enables consideration and use, in planning, of object(s) that may not be observable by a robot at the time of the FF NL command and/or that may not be specified in the FF NL command. Yet further, the querying and utilization of the environment map enables robust and accurate robotic task performance without requiring the FF NL command to conform to any particular object classification syntax.

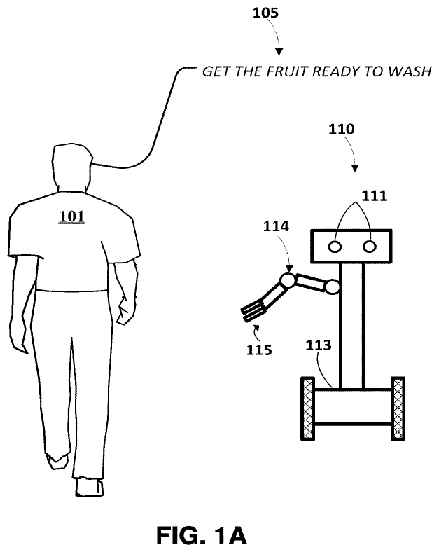

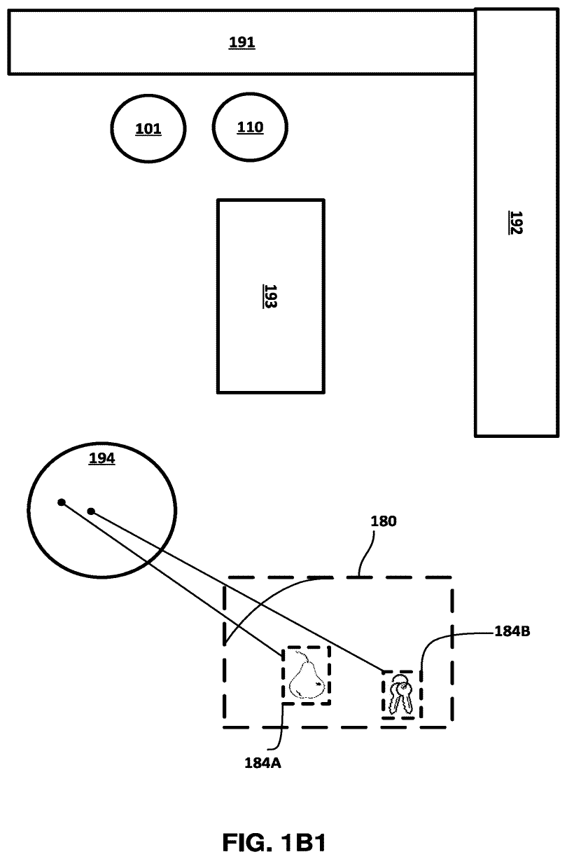

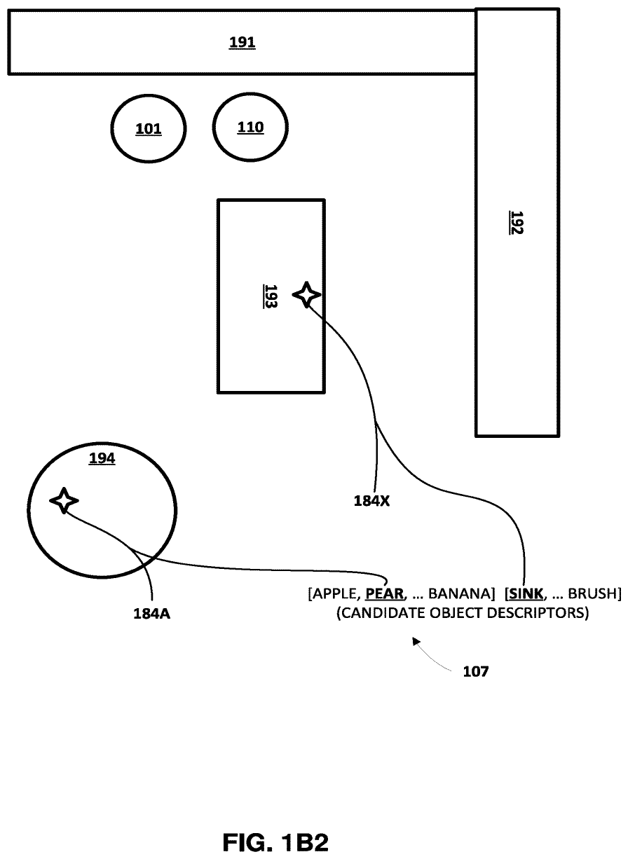

Turning now to the Figures, FIG. 1A illustrates an example of a human 101 providing a free-form (FF) natural language (NL) instruction 105 of “get the fruit ready to wash” to an example robot 110.

The robot 110 illustrated in FIG. 1A is a particular mobile robot. However, additional and/or alternative robots can be utilized with techniques disclosed herein, such as additional robots that vary in one or more respects from robot 110 illustrated in FIG. 1A. For example, a mobile forklift robot, an unmanned aerial vehicle (“UAV”), a non-mobile robot, and/or a humanoid robot can be utilized instead of or in addition to robot 110, in techniques described herein.

Robot 110 includes a base 113 with wheels provided on opposed sides thereof for locomotion of the robot 110. The base 113 may include, for example, one or more motors for driving the wheels of the robot 110 to achieve a desired direction, velocity, and/or acceleration of movement for the robot 110. The robot 110 also includes robot arm 114 with an end effector 115 that takes the form of a gripper with two opposing “fingers” or “digits.” Robot 110 also includes a vision component 111 that can generate vision data (e.g., images) related to shape, color, depth, and/or other features of object(s) that are in the line of sight of the vision component 111. The vision component 111 can be, for example, a monocular camera, a stereographic camera (active or passive), and/or a 3D laser scanner. A 3D laser scanner can include one or more lasers that emit light and one or more sensors that collect data related to reflections of the emitted light. The 3D laser scanner can generate vision component data that is a 3D point cloud with each of the points of the 3D point cloud defining a position of a point of a surface in 3D space. A monocular camera can include a single sensor (e.g., a charge-coupled device (CCD)), and generate, based on physical properties sensed by the sensor, images that each includes a plurality of data points defining color values and/or grayscale values. For instance, the monocular camera can generate images that include red, blue, and/or green channels. Each channel can define a value for each of a plurality of pixels of the image such as a value from 0 to 255 for each of the pixels of the image. A stereographic camera can include two or more sensors, each at a different vantage point. In some of those implementations, the stereographic camera generates, based on characteristics sensed by the two sensors, images that each includes a plurality of data points defining depth values and color values and/or grayscale values. For example, the stereographic camera can generate images that include a depth channel and red, blue, and/or green channels.

Robot 110 also includes one or more processors that, for example: process FF NL input and map data to determine object descriptor(s) relevant to a robotic task of the FF NL input; determine, based on the FF NL input and the object descriptor(s), robotic skill(s) for performing the robotic task; control a robot, during performance of the robotic task, based on the determined robotic skill(s); etc. For example, one or more processors of robot 110 can implement all or aspects of method 200, 300, 400, and/or 500 described herein. Additional description of some examples of the structure and functionality of various robots is provided herein.

Turning now to FIG. 1B1, a simplified birds-eye view of an example environment, in which the human 101 and the robot 110 of FIG. 1A are located, is illustrated. The human 101 and the robot 110 are represented as circles in FIG. 1B1. Further, environmental features 191, 192, 193, and 194 are illustrated in FIG. 1B1. The environmental features 191, 192, 193, and 194 illustrate outlines of landmarks the environment. For example, the environment could be an office kitchen or a work kitchen, and features 191 and 192 can be countertops, feature 193 can be a kitchen island, and feature 194 can be a round table.

Also illustrated in FIG. 1B1 is an example vision data instance 180 that was previously captured in the environment. For example, robot 110 may have previously captured the vision data instance 180, using vision component 111, during a previous exploration of the environment of FIG. 1B1. The vision data instance 180 captures a pear and keys that are both present on the round table represented by feature 194. It is noted that, in the birds-eye view, the pear, the keys, and other objects of the environment are not illustrated for the sake of simplicity.

A region of interest 184A, of the vision data instance 180, is also illustrated and encompasses the pear in the vision data instance. A region of interest 184B, of the vision data instance 180, is also illustrated and encompasses the keys in the vision data instance 180. As described herein, the vision data instance 180 can be processed, using a class-agnostic object detection model, to identify the regions of interest 184A and 184B. Further, the vision data, of the vision data instance that corresponds to the region of interest 184A, can be processed using a visual language model (VLM) encoder to generate a region embedding for the region of interest 184A. An estimated map location, represented by the circle at the end of the line connecting the region of interest 184A to the round table represented by feature 194, can also be determined for the region of interest 184A. The region embedding for the region of interest 184A can be stored in association with the estimated map location for the region of interest 184A and optionally in association with a size of the region of interest.

Yet further, the vision data, of the vision data instance that corresponds to the region of interest 184B, can be processed using the VLM encoder to generate a region embedding for the region of interest 184B. An estimated map location, represented by the circle at the end of the line connecting the region of interest 184B to the round table represented by feature 194, can also be determined for the region of interest 184B. The region embedding for the region of interest 184B can be stored in association with the estimated map location for the region of interest 184B and optionally in association with the size of the region of interest.

Only a single vision data instance is illustrated in FIG. 1B1 for sake of simplicity.

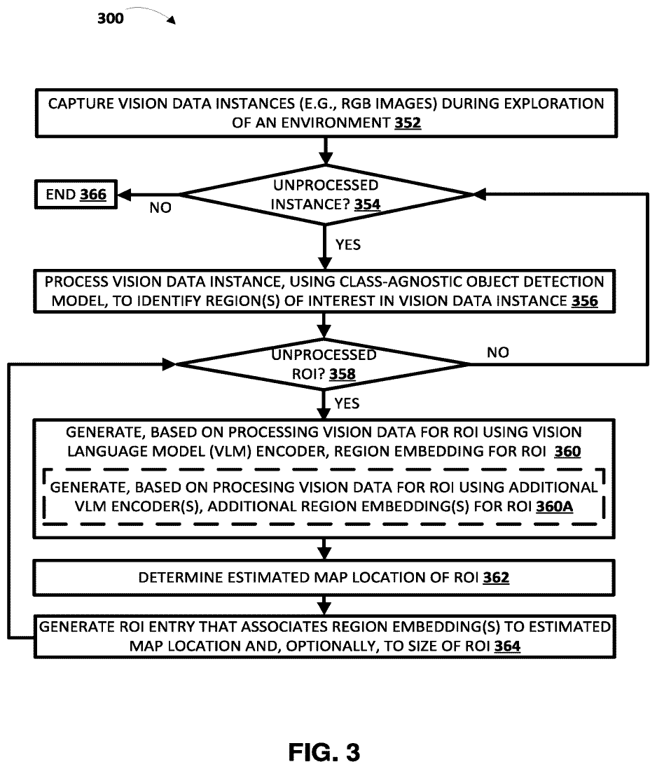

However, it is noted that many additional vision data instances will have been previously captured in the environment, and regions of interest and corresponding region embeddings and estimated map locations similarly determined for those vision data instances, and associated data stored for utilization in techniques disclosed herein. Method 300 (e.g., FIG. 3), described below, includes additional disclosure of implementations of identifying regions of interest, generating region embeddings for regions of interest, etc.

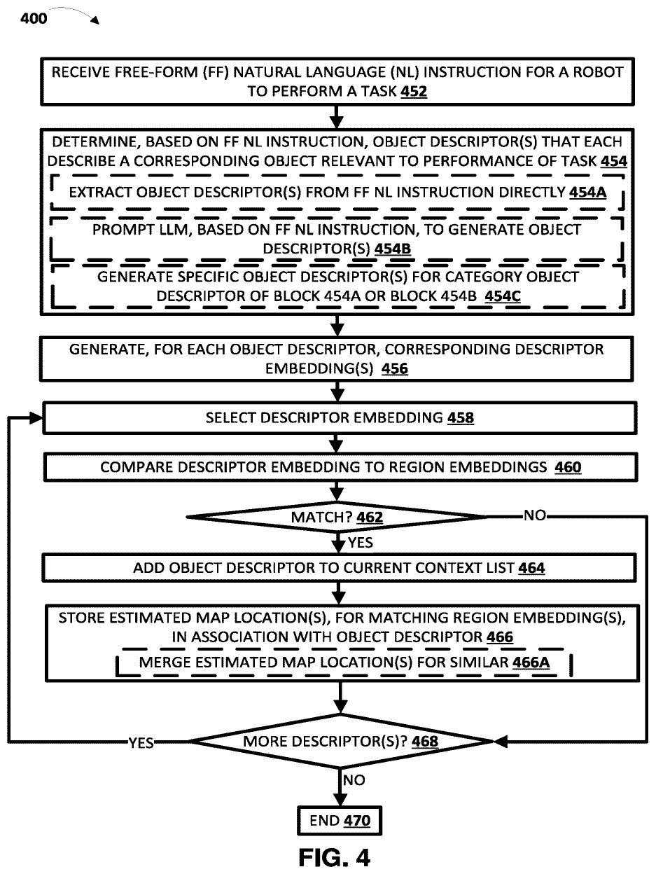

FIG. 1B2 illustrates the same birds-eye view of FIG. 1B1. FIG. 1B2 also illustrates locations in the environment (represented by stars), of previously determined regions of interest 184A and 184X, that have been determined to be relevant to a task of the FF NL instruction 105 of FIG. 1A. More particularly, FIG. 1B2 illustrates candidate object descriptors 107 that each describe a corresponding object that is potentially relevant to the task of the FF NL instruction 105 of FIG. 1A. For example, the candidate object descriptors 107 can be generated in block 454 of method 400 of FIG. 4, described below. For instance, “apple”, “pear”, and “banana” of the object descriptors 107 can be generated based on being determined to be members of a “fruit” class, and “fruit” being included in the FF NL instruction 105. Also, for instance, “sink” and “brush” can be generated based on prompting a large language model (LLM) using the FF NL instruction 105. Notably, even though the FF NL instruction 105 doesn't mention “sink”, “brush”, or any synonyms, prompting the LLM and analyzing resulting LLM output can still result in those object descriptors being determined to be potentially relevant to the task of the FF NL instruction 105.

Further, FIG. 1B2 illustrates that the candidate object descriptor “pear” has been determined to be relevant to the region of interest 184A. For example, a text embedding of “pear” can be compared to a region embedding of the region of interest 184A, and the comparison can indicate at least a threshold degree of similarity between the two embeddings. As a result of “pear” being determined to be relevant to the region of interest 184A, “pear” can be utilized in task planning and/or the location, of the region of interest 184A (and, optionally, location(s) of similar region(s) of interest as described herein), can be utilized in task planning. For example, “pear” can be processed, using the LLM and along with the FF NL instruction, to determine robotic skill(s) to implement to accomplish the task specified by the FF NL instruction 105. As another example, the location of the region of interest 184A can be utilized in implementing a determined robotic skill that is directed to “pear”. For instance, a “navigate to pear” skill can be implemented by utilizing the location of the region of interest 184A.

Yet further, FIG. 1B2 illustrates that the candidate object descriptor “sink” has been determined to be relevant to the region of interest 184X (which can correspond to a sink located in the island represented by feature 193). For example, a text embedding of “sink” can be compared to a region embedding of the region of interest 184X (the region embedding can be generated based on vision data that captures the “sink”), and the comparison can indicate at least a threshold degree of similarity between the two embeddings. As a result of “sink” being determined to be relevant to the region of interest 184X, “sink” can be utilized in task planning and/or the location, of the region of interest 184X (and, optionally, location(s) of similar region(s) of interest as described herein), can be utilized in task planning. For example, “sink” can be processed, using the LLM and along with the FF NL instruction, to determine robotic skill(s) to implement to accomplish the task specified by the FF NL instruction 105.

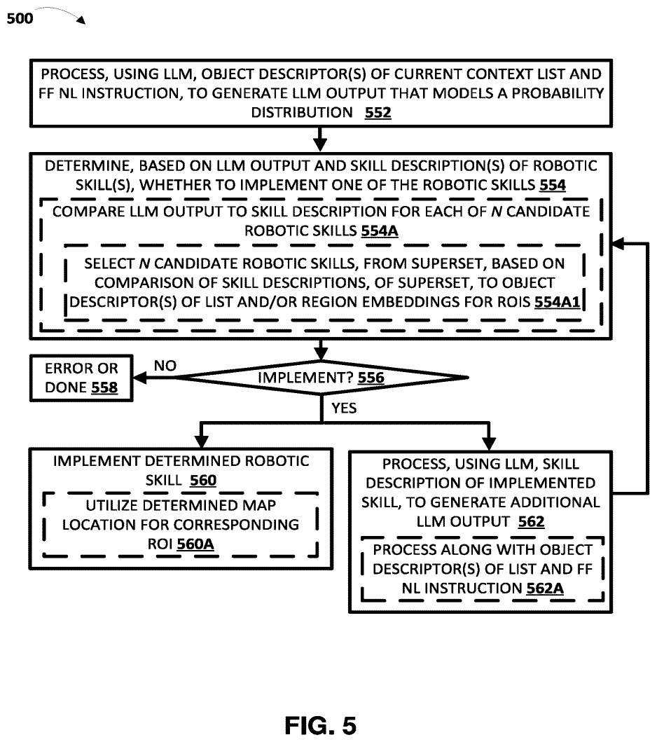

Further examples of determining candidate object descriptor(s) that are relevant to region(s) of interest is provided herein in, for example, blocks 460 and 462 of method 400 of FIG. 4. Also, further examples of utilization of such relevant object descriptor(s) and/or of location(s) of relevant region(s) of interest is provided herein in, for example, method 500 of FIG. 5.

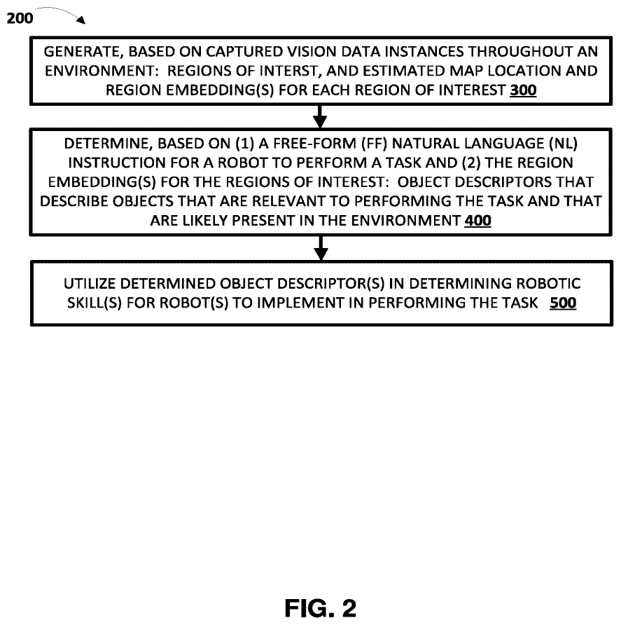

Turning now to FIG. 2, a flowchart is illustrated of an example method 200 of controlling a robot, based on FF NL input and based on descriptor(s) of objects that are: (a) present in an environment with the robot and (b) relevant to the FF NL input. For convenience, the operations of the method 200 are described with reference to a system that performs the operations. This system can include one or more components of a robot, such as a robot processor and/or robot control system of robot 110, robot 620, and/or other robot and/or can include one or more components of a computer system, such as computer system 710.

Moreover, while operations of method 200 are shown in a particular order, this is not meant to be limiting. One or more operations can be reordered, omitted or added.

At block 300, the system generates, based on captured vision data instances throughout an environment: regions of interest, and an estimated map location and region embedding(s) for each region of interest. At block 300, the system can further store at least the estimated location and the region embedding(s), for each region of interest and in association with one another, for utilization in e.g., block 400 and/or block 500.

For example, at block 300 the system can process each captured vision data instance, using a class-agnostic object detection model, to detect region(s) of interest in the vision data instance, if any. A class-agnostic object detection model can be a machine learning model trained to generate output that indicates a corresponding bounding box (or other geometric shape) for any object(s) of a vision data instance. A corresponding bounding box (or other geometric shape) can indicate the region of interest in the vision data instance. A class-agnostic object detection model is class-agnostic in that it is trained to detect any object (e.g., to detect “objectness”) and not just object(s) that are of certain defined class(es).

Further, for each detected region, the system can determine an estimated map location of the detected region. For example, the system can determine the estimated map location as a function of localization of the corresponding vision component that captured the vision data instance, the location of the region of interest within the vision data instance, and, optionally, depth data of the image (if available). Further, for each detected region, the system generates region embedding(s), for that region, based on processing vision data, from the vision data instance, that is within the region of interest. For instance, pixels within the region of interest can be processed using a visual language model (VLM) encoder to generate a region embedding. The VLM encoder can be trained for predicting natural language descriptions of images. For example, the VLM encoder can be trained for predicting a probability distribution over a vocabulary of natural language descriptions of images, such as a vocabulary of hundreds or thousands of natural language descriptions. In such an example, the probability distribution (or output of earlier layer(s) of the model) can be used as the region embedding. Non-limiting examples of VLM encoders include a Contrastive Language-Image Pretraining (CLIP) encoder and a Variational Imitation Learning with Diverse-quality Demonstrations (VILD) encoder.

Optionally, multiple region embeddings are generated for each ROI, and each is generated using a different VLM encoder. This enables utilization of the multiple region embeddings in, for example, block 400 (described below). This can be beneficial as some type(s) of embeddings are more robust for certain type(s) of objects (e.g., out of distribution objects) and other type(s) of embeddings are more robust for certain other type(s) of objects (e.g., common objects).

The environment in which the vision data instances, utilized by the system at block 300, are captured is a constrained and optionally defined space in which the robot, referenced in block 500 (below), at least selectively operates. The environment can be, for example, a room in a building, multiple rooms in a building, an entire floor of a building, and/or the entirety of a building. In some implementations, the environment in which a robot operates can be dictated by human input (e.g., defining areas to which the robot is confined and/or defining areas to which the robot is prohibited from entering) and/or can be dictated by constraint(s) of the robot (e.g., a robot may be incapable of navigating stairs, opening any or certain type(s) of doors, etc.).

The vision data instances utilized by the system at block 300 can be generated by one or more vision components that were (and perhaps still are) in the environment. Such vision component(s) can include, vision component(s) of the robot referenced in block 500 (below), vision component(s) of additional robot(s) previously (and perhaps currently) in the environment, and/or other fixed or non-fixed vision component(s) in the environment. In some implementations, the vision data instances include (or are restricted to) images that include multiple color channels (e.g., red, green, and blue (RGB) channels) and/or that include a depth (D) channel. For example, the vision data instances can include RGB images generated by a monocular camera vision component and/or RGB-D images generated by a stereographic camera vision component. One or more of the vision data instances utilized by the system at block 300 can optionally be generated by robot(s), during exploration of the environment, such as exploration using pre-determined waypoints in the environment and/or exploration using frontier exploration algorithms.

At block 400, the system determines, based on (1) a FF NL instruction for a robot to perform a task and (2) region embedding(s) for the regions of interest generated in block 300: object descriptors that describe objects that are relevant to performing the task and that are likely present in the environment.

For example, at block 400 the system can determine, based on the FF NL instruction, a superset of candidate object descriptors that each describe an object that is relevant to performing the task. For instance, the system can determine, for inclusion in the superset, object descriptor(s) that are explicitly present in the FF NL instruction and/or object descriptor(s) that are not explicitly present in, but derivable from, the FF NL instruction.

Further, at block 400 the system can compare text embeddings, for the object descriptors, to region embeddings for the regions of interest. For example, a comparison of a text embedding to a region embedding can include generating a result of an inner product between the embeddings, determining a Euclidean distance measure between the embeddings, and/or other comparison between the embeddings. The comparison of a text embedding to a region embedding can produce a measure (e.g., result of inner product, distance measure, etc.) that indicates likelihood that the text (corresponding to the text embedding) is descriptive of a region of interest (corresponding to the region embedding). Any object descriptors, whose text embedding is not close to any (or at least a threshold quantity of) of the region embeddings, as indicated by the comparison (e.g., corresponding measure(s) fail to satisfy threshold(s)), can be excluded from a subset of the superset of object descriptors. Any object descriptors, whose text embedding is close to any (or at least a threshold quantity of) the region embeddings, can be included in a subset of the superset of object descriptors.

Accordingly, the determined subset of object descriptors are descriptive of object(s) that: (a) are relevant to performing the task of the FF NL instruction and (b) are likely included in the environment (as indicated by the text embedding(s) of their corresponding object descriptor(s) being close to region embedding(s)).

In these and other manners, implementations enable the system to efficiently, and with low latency, determine object descriptors that describe objects that are both relevant to performing a task of an FF NL instruction and are likely present in the environment. Further, previously generated region embeddings, for regions of interest, can be utilized in such a determination—preventing the need for on-demand exploration to identify object(s) that are both relevant to performing a task of an FF NL instruction and are likely present in the environment. Yet further, comparing text embeddings and region embeddings and/or other techniques described herein enable identification of object(s) in the environment that are relevant to an FF NL instruction, without the FF NL instruction needing to conform to any object classification grammar.

At block 500, the system utilizes the determined object descriptor(s), determined in block 400, in determining robotic skill(s) for robot(s) to implement in performing the task specified in the FF NL instruction of block 400. As described above, the determined object descriptors can be a subset that describe objects that are both relevant to performing a task of an FF NL instruction and likely present in the environment. At block 500, the system can utilize such a subset, without other object descriptor(s), in determining robotic skill(s) for robot(s) to implement in performing the task. This can prevent wastefully considering robotic skill(s) that are specific to object(s) that do not correspond to the object descriptor(s) of the subset and/or wasteful erroneous selection (and implementation) of such robotic skills.

In some implementations, at block 500 the system, in utilizing the determined object descriptor(s), determined in block 400, in determining robotic skill(s) for robot(s) to implement in performing the task, generates instances of large language model (LLM) output based on processing the determined object descriptors, and the FF NL instructions, using an LLM. In some of those implementations, the system further uses the instance(s) of LLM output in determining robotic skills for robot(s), in the environment, to implement in performing the task.

Turning now to FIGS. 3, 4, and 5, non-limiting examples of blocks 300, 400, and 500 of method 200 of FIG. 2 are described. For convenience, and like with FIG. 2, the operations of the methods 300, 400, and 500 are described with reference to a system that performs the operations. This system can include one or more components of a robot, such as a robot processor and/or robot control system of robot 110, robot 620, and/or other robot and/or can include one or more components of a computer system, such as computer system 710.

Moreover, while operations of methods 300, 400, and 500 are shown in a particular order, this is not meant to be limiting. One or more operations can be reordered, omitted or added.

Turning initially to FIG. 3, a flowchart illustrating implementations of block 300 of the method of FIG. 2 is provided.

At block 352, the system captures vision data instances during exploration of an environment. For example, the vision data instances can include RGB images or RGB-D images of vision component(s) of one or more robot(s) and the exploration can be by the robot(s) using waypoint exploration and/or frontier exploration techniques.

At block 354, the system determines whether there are unprocessed vision data instances from those captured at block 352. If not, the system proceeds to block 366 and method 300 ends, but can optionally be performed again in response to, for example, further exploration of the environment and/or additional instances of vision data of the environment being captured during non-exploration task performance. If, at block 354, the system determines there are unprocessed vision data instances, the system proceeds to block 356.

At block 356, the system processes a vision data instance, using a class-agnostic object detection model, to identify region(s) of interest in the vision data instance. For example, processing the vision data instance, using the class-agnostic object detection model, can generate output that indicates region(s) of interest, such as bounding box(es) or other geometric region(s) of the vision data instance.

At block 354, the system determines whether there are unprocessed region(s) of interest from the vision data instance. If not, the system proceeds back to block 354. If so, the system selects an unprocessed region of interest (ROI) and proceeds to block 360.

At block 360, the system generates, based on processing vision data, for the selected region of interest (ROI) and using a VLM encoder, a region embedding for the ROI. For example, the vision data instance can be an image, the region of interest can bound pixels of the image, and the system can process the bound pixels (exclusively, and optionally after scaling) using the VLM encoder to generate the region embedding. The region embedding can be the final output of the VLM encoder or, optionally, an intermediate output of the VLM encoder.

Block 360 optionally includes block 360A, in which the system generates additional region embedding(s) for the selected ROI. Each of the additional regional embedding(s) can be generated based on processing vision data, for the selected region of interest (ROI), using a corresponding additional VLM encoder. For example, block 360 can include processing bounded pixels, of a region of interest, using a first VLM encoder to generate a first region embedding, using a second VLM encoder to generate a second region embedding, and using a third VLM encoder to generate a third region embedding.

At block 362, the system determines an estimated map location of the selected ROI. For example, the system can determine the estimated map location as a function of localization of the corresponding vision component that captured the vision data instance, the location of the region of interest within the vision data instance, and, optionally, depth data of the image (if available). For instance, where the vision component is a robot vision component, localization of the robot in a world map can be used, along with a pose of the vision component (e.g., relative to a robot reference point) and a location of the region of interest within the vision data instance, in estimating the map location. The estimated map location can be, for example, a 3-dimensional location (X, Y, Z) or 4-dimensional location (including height) in Cartesian space and with reference to a reference point of a map of the environment. It is noted that, in various implementations, the estimated map location does not fully specify a 6-dimensional pose of an associated object of the region of interest. Rather, it may only specify locational dimensions of the associated object, without any specification of orientation of the associated object.

At block 364, the system generates an entry that associates region embedding(s) (generated at block 360) for the selected ROI to the estimated map location (generated at block 362) for the selected ROI and, optionally, to a size of the selected ROI (e.g., a height/width when the ROI is a bounding box-or just one value when height/width are the same). For example, the entry can include a unique identifier for the ROI and can associate (e.g., with a pointer or other database mapping) that unique identifier with the region embedding(s) for the ROI, the estimated map location of the ROI and, optionally, a size of the ROI.

The system then proceeds back to block 358.

Turning next to FIG. 4, a flowchart illustrating implementations of block 400 of the method of FIG. 2 is provided.

At block 452, the system receives an FF NL instruction for a robot to perform a task. For example, the instruction can be a spoken utterance that is provided by a human in the environment with the robot, and audio data that captures the spoken utterance can be processed, using an automatic speech recognition (ASR) model, to generate a transcription that includes the FF NL instruction. The audio data can be captured via microphone(s) of the robot, or elsewhere in the environment, and the ASR model (and associated processing) can be on the robot or other computing device(s) in the environment.

At block 454, the system determines, based on the FF NL instruction, object descriptor(s) that each describe a corresponding object relevant to performance of the robotic task. In determining the object descriptor(s), the system optionally performs sub-block(s) 454A, 454B, and/or 454C.

At sub-block 454A, the system extracts object descriptor(s) from the FF NL instruction directly. For example, the system can extract noun(s) and/or adjective(s) from the FF NL instruction directly. For instance, if the NL instruction is “give me some first-aid items”, “first-aid items” can be extracted.

At sub-block 454B, the system prompts an LLM, based on the FF NL instruction, to generate object descriptor(s). The LLM can be distinct from the LLM described in FIG. 5 or can be the same as that described in FIG. 5, but optionally primed and/or prompted differently.

For example, the LLM can be distinct and can be trained to generate object descriptor(s) of object(s) that are relevant to an NL input processed using the LLM. For instance, processing NL input using the LLM model can generate LLM output that includes a probability distribution, over candidate word compositions, where the probability distribution can be utilized to select word composition(s) and, due to training of the LLM, the selected word composition(s) will be relevant to the NL input. The system can process all or portions of the FF NL input, using the LLM, in generating object descriptor(s) at sub-block 454B. As one example of sub-block 454B, if the FF NL instruction is “light up the room”, the system can prompt the LLM, based on the FF NL instruction, to generate LLM output that indicates object descriptor(s) that include “switch”. It is noted that the LLM output can indicate “switch” despite the FF NL instruction not including that term or any synonyms of that term.

At sub-block 454C, the system generates specific object descriptor(s) for a category object descriptor determined at block 454A or determined at block 454B. For example, the system can determine that an object descriptor, determined at block 454A or determined at block 454B, is a category object descriptor descriptive of a category and, in response, generate specific object descriptor(s), for the category, that are each descriptive of a corresponding member of that category. The system can utilize a knowledge graph or other ontological structure in determining category object descriptors and corresponding specific object descriptor(s). As one example, of sub-block 454C, for a category object descriptor of “fruit”, the system can determine specific object descriptors such as “banana”, “apple”, “orange”, etc.

At block 456, the system generates, for each object descriptor determined at block 454, corresponding descriptor embedding(s). For example, the system can generate a descriptor embedding, for an object descriptor, based on processing the descriptor embedding using a text encoder, which can be a trained machine learning model. The text encoder can optionally be one utilized in training the VLM encoder that is utilized in method 300 of FIG. 3.

At block 458, the system selects a descriptor embedding, from those generated at block 456.

At block 460, the system compares the selected descriptor embedding to region embeddings for regions of interest in the environment. The region embeddings can be those generated and stored in a most recent iteration of method 300 of FIG. 3. For example, a comparison of a selected descriptor embedding to a region embedding can include generating a result of an inner product between the embeddings, determining a Euclidean distance measure between the embeddings, and/or other comparison between the embeddings. The comparison of the two embeddings can produce a measure (e.g., result of inner product, distance measure, etc.) that indicates likelihood that the selected descriptor (corresponding to the selected descriptor embedding) is descriptive of a region of interest (corresponding to the region embedding).

At block 462, the system determines whether the comparison, of block 460, indicates that the descriptor embedding matches any of (or at least a threshold quantity of) the region embeddings. For example, when the comparison of block 460 includes generating a measure of similarity for the comparison of the selected descriptor embedding to each of the regions embedding, a match can be determined when the measure of similarity satisfies a threshold.

If, at block 462, the system determines that the descriptor embedding does not match any (or at least a threshold quantity of) the region embeddings, the system proceeds to block 468. If, at block 462, the system determines that the descriptor embedding does match at least one of (or at least a threshold quantity of) the region embeddings, the system proceeds to block 464.

At block 464, the system adds the selected object descriptor, corresponding to the selected descriptor embedding, to a current context list. Accordingly, a selected object descriptor is added to the current context list when the comparison, of block 460, indicates that it is sufficiently descriptive of object(s) in the environment.

At block 466 the system stores the estimated map location(s), for the matching region embedding(s), in association with the object descriptor. For example, if the object descriptor is “fruit” it can be stored in association with estimated map location(s) for region(s) of interest that capture a particular banana and stored in association with other estimated map location(s) for region(s) of interest that capture a “pear”.

At block 466, the system optionally, at sub-block 466A, merges the estimated map location(s) for similar matching region embedding(s). For example, it can be the case that there are five different regions of interest that are each generated based on a different vision data instance, but that each capture the same object. Further, one or more of those five different regions can have a differing estimated map location due to, for example, inaccuracies in generating the corresponding estimated map locations. Accordingly, the system can identify similar matching region embeddings, and merge their respective estimated map location(s) into a single estimated map location. For example, the single estimated map location can be an average of the estimated map location(s). In these and other manners the system can determine that multiple regions of interest relate to the same object, and treat them effectively as a single merged region of interest. In determining that matching region embeddings are similar to one another, the system can compare the region embeddings themselves, their estimated map location, and/or their size. For example, if a first and second region embedding are close to one another (e.g., within a threshold distance in embedding space), their estimated map locations are close to one another (e.g., within a threshold distance in Cartesian space), and/or their sizes are close to one another (e.g., within a threshold percentage of one another), then the region embeddings can be determined to be similar to one another. Put another way, it can be determined that the region embeddings relate to the same object.

At block 468, the system determines whether there are more unprocessed descriptor(s). If so, the system proceeds to block 458 and selects another descriptor embedding, for another object descriptor. If not, the system proceeds to block 470 and method 400 ends. Method 400 can be performed again when a new FF NL instruction is received.

Turning next to FIG. 5, a flowchart illustrating implementations of block 500 of the method of FIG. 2 is provided.

At block 552, the system processes, using an LLM, object descriptor(s) of a current context list and an FF NL instruction, to generate LLM output that models a probability distribution. The object descriptor(s) of the current context list, processed by the system in block 552, can be those from the current context list generated through iterations of block 464 of method 400 of FIG. 4. The FF NL instruction, processed by the system in block 552, can be the one received in block 452 of method 400 of FIG. 4.

At block 554, the system determines, based on the LLM output and skill description(s) of robotic skill(s), whether to implement one of the robotic skills. At a first iteration of block 554, the LLM output is that which is generated at block 552. At further iterations of block 554, the LLM output is that which is generated at a most recent iteration of block 562.

In some implementations, at block 554, the LLM output can model a probability distribution over word compositions and the system can generate, for each of the skill description(s), a corresponding skill grounding measure that reflects a probability of the skill description, and its corresponding robotic skill, in the LLM output. Put another way, the skill grounding measure for a skill description can reflect the probability of that skill description (and the corresponding robotic skill) as reflected in the probability distribution of the LLM output. In some of those implementations, the system can determine to implement a robotic skill when the skill grounding measure, for its skill description: (a) is the highest probability skill grounding measure amongst all skill grounding measures generated at an iteration of block 554 and, optionally, (b) satisfies a threshold. Further, in some of those implementations, the system can determine to not implement any robotic skill when all skill grounding measures generated at an iteration of block 554 fail to satisfy the threshold. In some additional or alternative implementations, at block 554 the system also generates a grounding measure for a “done” description (e.g., a description that indicates the task is completed/finished and/or that indicates the task is not accomplishable). In some of those implementations, the system can determine to not implement any robotic skill when the grounding measure for the “done” description is the highest probability and/or satisfies a threshold. Regardless of technique(s) utilized in determining to not implement any robotic skill, when such a determination is made at a first iteration of block 554, this can indicate that the robot is unable to perform the task (e.g., needed environmental object(s) are not available and/or needed robotic skill(s) are not implementable by the robot). When such a determination is made at a subsequent iteration of block 554, this can indicate that performance of the task is completed (e.g., already implemented robotic skill(s) have completed the task).

Block 554 can include sub-block 554A. At block 554A, the system, in determining based on the LLM output and the skill description(s), compares the LLM output to the skill description for each of N candidate robotic skills, where N is a subset of a superset of M robotic skills that are performable by the robot. Sub-block 554A can include optional further sub-block 554A1, in which the system selects the N candidate robotic skills, from the superset of M robotic skills, based on comparison of the skill descriptions, for the superset of M robotic skills, to object descriptor(s) of the current context list (e.g., determined at iteration(s) of block 464 of method 400 of FIG. 4) and/or to region embeddings for regions of interest (e.g., determined at iteration(s) of block 360 of method 300 of FIG. 3). For example, the system can compare text embeddings, of at least part of the skill descriptions of the superset of M robotic skills (e.g., at least the part that describes object(s) that can be interacted with based on the robotic skill), to text embeddings of the object descriptor(s) and/or to region embeddings. Further, the system can select the N candidate robotic skills whose comparison indicates at least a threshold degree of similarity. In these and other manners, the subset of N candidate robotic skills can include only those skills that are relevant to the object descriptor(s) of the current context list and/or to the objects in the environment (as indicated by the region embeddings). Such selecting of a subset of N candidate robotic skills can prevent erroneous determination, at block 554, to implement a robotic skill that is irrelevant to the task and/or is not performable given current environmental objects. Such selecting of a subset of N candidate robotic skills can additionally or alternatively enable efficient comparison of LLM output to corresponding candidate skill descriptions.

As a particular example of block 554A, assume the object descriptor(s) of the current context list include “banana” but exclude “bottle”, “drink container” or any similar descriptor(s). Further assume that “pick up fruit” is a skill descriptor for a candidate robotic skill and that “pick up bottle” is a skill descriptor for a separate candidate robotic skill. In such an example, the “pick up fruit” candidate robotic skill can be selected at block 554A based on comparison of a text embedding for “banana” and a text embedding for “fruit” indicating a threshold degree of similarity. However, the “pick up bottle” candidate robotic skill can be excluded at block 554A based on comparison of a text embedding of “bottle”, to text embeddings of object descriptor(s) of the current list, failing to indicate the threshold degree of similarity.

At block 556, the system determines to proceed to block 558 when the determination, at block 554, is to not implement any of the robotic skills. When the system proceeds to block 558 at a first iteration of block 554, the system determines an “error”, indicating that the task cannot be performed. Optionally, the system provides user interface output (e.g., audible, visual, and/or haptic) to indicate, to human user(s), that the task cannot be performed. When the system proceeds to block 558 at a subsequent iteration of block 554, the system determines the task is complete. Optionally, the system provides user interface output (e.g., audible, visual, and/or haptic) to indicate, to human user(s), that the task is complete.

At block 556, the system determines to proceed to blocks 560 and 562 when the determination, at block 554, is to implement one of the robotic skills.

At block 560, the system implements the determined robotic skill (determined at a most recent iteration of block 554). For example, if the determined robotic skill has a skill descriptor of “navigate to banana”, the system can implement the determined robotic skill, causing the robot to navigate to a banana in the environment.

In some implementations, block 560 includes sub-block 560A in which the system, in implementing the robotic skill, utilizes the determined map location for a corresponding region of interest (e.g., those corresponding to matching region embedding(s) determined at iteration(s) of block 466 of method 400). For example, if the determined robotic skill has a skill descriptor of “navigate to banana”, the system can determine region embedding(s), for region(s) of interest, that have a threshold degree of similarity to the text embedding for “banana”. Further, the system can utilize a map location, for one of those region embedding(s), in implementing the “navigate to banana” robotic skill (e.g., the robotic skill can navigate to the map location). The map location can be, for example, a merged estimated map location determined in an iteration of sub-block 466A of method 400 of FIG. 4.

At block 562, the system processes, using the LLM, the skill description of the implemented robotic skill, to generate additional LLM output, then proceeds back to block 554 to perform another iteration of block 554 that considers the additional LLM output. In some implementations, block 554 includes sub-block 554A, in which the system processes, using the LLM, the skill description of the implemented robotic skill and the object descriptor(s) of the current context list and the FF NL instruction.

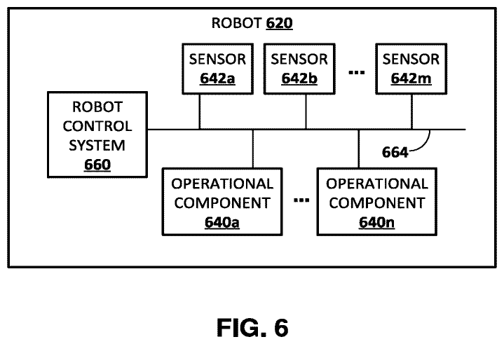

FIG. 6 schematically depicts an example architecture of a robot 620. The robot 620 includes a robot control system 660, one or more operational components 640a-640n, and one or more sensors 642a-642m. The sensors 642a-642m may include, for example, vision sensors, light sensors, pressure sensors, pressure wave sensors (e.g., microphones), proximity sensors, accelerometers, gyroscopes, thermometers, barometers, and so forth. While sensors 642a-m are depicted as being integral with robot 620, this is not meant to be limiting. In some implementations, sensors 642a-m may be located external to robot 620, e.g., as standalone units.

Operational components 640a-640n may include, for example, one or more end effectors and/or one or more servo motors or other actuators to effectuate movement of one or more components of the robot. For example, the robot 620 may have multiple degrees of freedom and each of the actuators may control the actuation of the robot 620 within one or more of the degrees of freedom responsive to the control commands. As used herein, the term actuator encompasses a mechanical or electrical device that creates motion (e.g., a motor), in addition to any driver(s) that may be associated with the actuator and that translate received control commands into one or more signals for driving the actuator. Accordingly, providing a control command to an actuator may comprise providing the control command to a driver that translates the control command into appropriate signals for driving an electrical or mechanical device to create desired motion.

The robot control system 660 may be implemented in one or more processors, such as a CPU, GPU, and/or other controller(s) of the robot 620. In some implementations, the robot 620 may comprise a “brain box” that may include all or aspects of the control system 660. For example, the brain box may provide real time bursts of data to the operational components 640a-n, with each of the real time bursts comprising a set of one or more control commands that dictate, inter alia, the parameters of motion (if any) for each of one or more of the operational components 640a-n. In some implementations, the robot control system 660 may perform one or more aspects of method(s) described herein, such as method 200 of FIG. 2, method 300 of FIG. 3, method 400 of FIG. 4, and/or method 500 of FIG. 5.

As described herein, in some implementations all or aspects of the control commands generated by control system 660, in controlling a robot during performance of a robotic task, can be generated based on robotic skill(s) determined to be relevant for the robotic task and, optionally, based on determined map location(s) for environmental object(s). Although control system 660 is illustrated in FIG. 6 as an integral part of the robot 620, in some implementations, all or aspects of the control system 660 may be implemented in a component that is separate from, but in communication with, robot 620. For example, all or aspects of control system 660 may be implemented on one or more computing devices that are in wired and/or wireless communication with the robot 620, such as computing device 710.

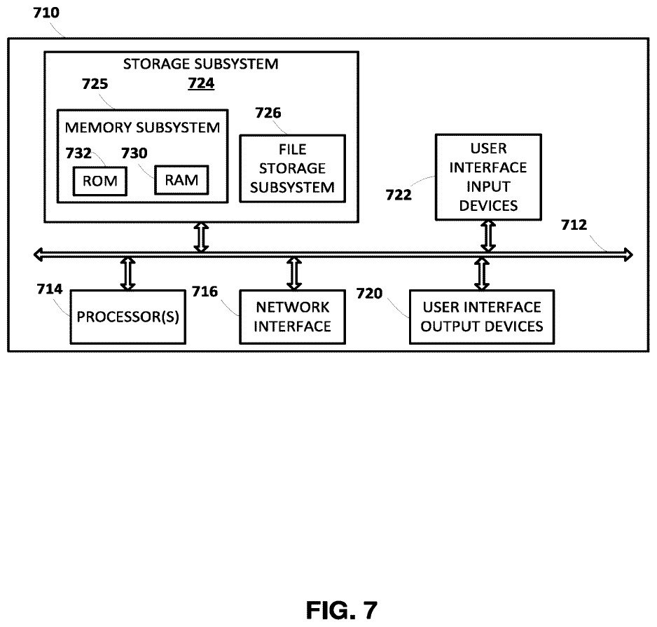

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the method 200 of FIG. 2, the method 300 of FIG. 3, the method 400 of FIG. 4, and/or the method 500 of FIG. 5.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

Other implementations can include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described herein. Yet other implementations can include a system of one or more computers and/or one or more robots that include one or more processors operable to execute stored instructions to perform a method such as one or more of the methods described herein.

In some implementations, a method is provided that includes identifying vision data instances that were captured, using one or more vision components, throughout an environment of at least one robot. The method further includes processing the vision data instances to identify regions of interest in the environment and to determine, for each of the regions of interest: an estimated location of the region of interest, and a region embedding, for the region of interest, that is in a natural language embedding space and that semantically corresponds to visual features of the region of interest. The method further includes, for each of the regions of interest, storing an association of the estimated location of the region of interest to the region embedding for the region of interest. The method further includes identifying an instruction for a robot to perform a task. The instruction is a free-form natural language instruction generated based on user interface input that is provided by a user via one or more user interface input devices. The method further includes determining, based on the instruction, object descriptors that each describe a corresponding candidate environmental object relevant to performance of the task. The method further includes comparing object descriptor embeddings, for the object descriptors, to the region embeddings, for the regions of interest, to identify: a subset of the object descriptors that each describe a corresponding object that is likely present in the environment. The method further includes, responsive to identifying the subset of object descriptors, processing the subset of object descriptors and the instruction, using a large language model (LLM), to generate LLM output. The LLM output can model a probability distribution, over candidate word compositions, that is dependent on the object descriptors and on the instruction. The method further includes determining, based on the LLM output and a skill description that is a natural language description of a robotic skill performable by the robot, to implement the robotic skill. The method further includes, in response to determining to implement the robotic skill: causing the robot to implement the robotic skill in the environment.

These and other implementations of the technology disclosed herein can include one or more of the following features.

In some implementations, the natural language description of the robotic skill includes a skill action descriptor and a skill object descriptor (e.g., one that conforms to one of the object descriptors of the subset). In some versions of those implementations, the method further includes (a) identifying a given region of interest, of the regions of interest, based on comparing a skill object descriptor embedding, for the skill object descriptor, to the region embedding for the given region of interest and (b) in response to identifying the given region of interest, using the estimated location of the region of interest in causing the robot to implement the robotic skill in the environment. In some variants of those versions, the robotic skill is a navigation skill and using the estimated location of the region of interest in causing the robot to implement the robotic skill in the environment includes causing the robot to navigate to a particular location that is determined based on the estimated location. In some additional or alternative variants of those versions, the method further includes: identifying an additional given region of interest, of the regions of interest, based on comparing the skill object descriptor embedding, for the skill object descriptor, to the region embedding for the additional given region of interest; determining, based on the estimated location of the region of interest and the estimated location of the additional region of interest, that the region of interest and the additional region of interest correspond to a same object; and in response to determining that the region of interest and the additional region of interest correspond to the same object, using the estimated location of the region of interest and the estimated location of the additional region of interest in causing the robot to implement the robotic skill in the environment. In some of those additional or alternative variants, the robotic skill is a navigation skill and using the estimated location of the region of interest and the estimated location of the additional region of interest in causing the robot to implement the robotic skill in the environment includes: (a) determining a particular location as a function of the estimated location of the region of interest the estimated location of the additional region of interest; and (b) causing the robot to navigate to the particular location. Further, in some of those additional or alternative variants, determining that the region of interest and the additional region of interest correspond to the same object is further based on comparing a first size, of the first region of interest, to a second size, of the second region of interest.

In some implementations, processing the vision data instances to identify the regions of interest in the environment and to determine, for each of the regions of interest, the estimated location and the region embedding includes, for a given vision data instance of the vision data instances: processing the given vision data instance, using a class-agnostic object detection model, to identify a given region of interest in the vision data instance; determining, based on the given region of interest and a pose of a vision component when the given vision data instance was captured, the estimated location for the given region of interest; and generating the region embedding, for the given region of interest, based on processing a portion, of the given vision data instance, that corresponds to the given region of interest.

Processing the portion can be using a visual language model (VLM) encoder trained for predicting natural language descriptions of images.

In some implementations, the method further includes, responsive to determining to implement the robotic skill: processing the subset of object descriptors, the instruction, and the skill description of the robotic skill, using the LLM, to generate additional LLM output that models an additional probability distribution, over the candidate word compositions, that is dependent on the object descriptors, the instruction, and the skill description; determining, based on the additional LLM output and an additional skill description that is an additional natural language description of an additional robotic skill performable by the robot, to implement the additional robotic skill; and in response to determining to implement the additional robotic skill: causing the robot to implement the additional robotic skill in the environment and after implementation of the robotic skill in the environment. In some of those implementations, the method further includes, responsive to determining to implement the additional robotic skill: processing the subset of object descriptors, the instruction, the skill description of the robotic skill, and the additional skill description of the additional robotic skill, using the LLM, to generate further LLM output that models an additional probability distribution, over the candidate word compositions, that is dependent on the object descriptors, the instruction, the skill description, and the additional skill description; and determining, based on the further LLM output, that performance of the task by the robot is complete.

In some implementations, the method further includes, responsive to determining to implement the robotic skill: processing the subset of object descriptors, the instruction, and the skill description of the robotic skill, using the LLM, to generate additional LLM output that models an additional probability distribution, over the candidate word compositions, that is dependent on the object descriptors, the instruction, and the skill description; and determining, based on the additional LLM output, that performance of the task by the robot is complete.

In some implementations, the method further includes generating the object descriptor embeddings. In some of those implementations, generating each of the object descriptor embeddings includes processing a corresponding one of the object descriptors, using a text encoding model, to generate a corresponding one of the object descriptor embeddings.

In some implementations, the object descriptors include one or more object descriptors that are not explicitly specified in the instruction. In some versions of those implementations, determining, based on the instruction, object descriptors that each describe a corresponding candidate environmental object relevant to performance of the task includes: processing the instruction, using the LLM or an additional LLM, to generate alternate LLM output; and determining one or more of the object descriptors based on the alternate LLM output. In some variants of those versions, the method further includes: determining, based on the alternate LLM output, a category descriptor of a category; and determining given descriptors, of the object descriptors, based on the given descriptors being descriptors of specific objects that are members of the category and based on the category descriptor being determined based on the alternate LLM output. In some additional or alternative variants of those versions, the method further includes: identifying a category descriptor, of a category, that is present in the instruction; and determining given descriptors, of the object descriptors, based on the given descriptors being descriptors of specific objects that are members of the category and based on the category descriptor being present in the instruction.

In some implementations, determining, based on the LLM output and the skill description that is the natural language description of the robotic skill, to implement the robotic skill, includes: determining that the probability distribution, of the LLM output, indicates the skill description with a probability that satisfies a threshold degree of probability and that the probability is greater than other probabilities determined for other candidate skill descriptions of other candidate robotic skills performable by the robot. In some versions of those implementations, the method further includes: selecting, from a superset of skills performable by the robot, only the robotic skill and the other candidate robotic skills; and in response to the selecting, determining the probability and the other probabilities for only the robotic skill and the other candidate robotic skills. In some of those versions, selecting only the robotic skill and the other candidate robotic skills is based on comparing the skill descriptor and the other skill descriptors to the subset of object descriptors and/or to the region embeddings for the regions of interest.

In some implementations, a method is provided that includes generating, based on processing vision data instances that were captured throughout an environment of one or more robots: regions of interest and, for each of the regions of interest, an estimated map location and a corresponding region embedding. The method further includes receiving a free form (FF) natural language (NL) instruction that is provided via one or more user interface input devices and that instructs a robot to perform a task. The method further includes determining, based on the FF NL instruction and the region embeddings for the regions of interest, object descriptors that each describe objects that are relevant to performing the task and that are likely present in the environment. The method further includes utilizing the determined object descriptors in determining robotic skills for at least one of the robot(s) to implement in performing the task.

These and other implementations of the technology disclosed herein can include one or more of the following features.

In some implementations, the method further includes causing the at least one of the robots to implement the robotic skills in the environment.

In some implementations, utilizing the determined object descriptors in determining the robotic skills for at least one of the robot(s) to implement in performing the task includes utilizing the determined object descriptors in large language model (LLM) based robotic planning. In some versions of those implementations, utilizing the determined object descriptors, in determining the robotic skills for at least one of the robot(s) to implement in performing the task includes generating instances of LLM output based on processing the determined object descriptors, and the FF NL instructions, using an LLM. In some of those versions, utilizing the determined object descriptors, in determining the robotic skills for at least one of the robot(s) to implement in performing the task includes using the instance(s) of LLM output in determining robotic skills for robot(s), in the environment, to implement in performing the task In some implementations, the method further includes utilizing at least one of the determined map locations in implementing one or more of the determined robotic skills.

1. A method implemented by one or more processors, the method comprising:
capturing, using one or more vision components, vision data instances throughout an environment of at least one robot;
processing the vision data instances to identify regions of interest in the environment and to determine, for each of the regions of interest:
an estimated location of the region of interest, and
a region embedding, for the region of interest, that is in a natural language embedding space and that semantically corresponds to visual features of the region of interest;
for each of the regions of interest, storing an association of the estimated location of the region of interest to the region embedding for the region of interest;
identifying an instruction for a robot to perform a task, the instruction being a free-form natural language instruction generated based on user interface input that is provided by a user via one or more user interface input devices;
determining, based on the instruction, object descriptors that each describe a corresponding candidate environmental object relevant to performance of the task;
comparing object descriptor embeddings, for the object descriptors, to the region embeddings, for the regions of interest, to identify:
a subset of the object descriptors that each describe a corresponding object that is likely present in the environment;
responsive to identifying the subset of object descriptors, processing the subset of object descriptors and the instruction, using a large language model (LLM), to generate LLM output that models a probability distribution, over candidate word compositions, that is dependent on the object descriptors and on the instruction;
determining, based on the LLM output and a skill description that is a natural language description of a robotic skill performable by the robot, to implement the robotic skill; and
in response to determining to implement the robotic skill:
causing the robot to implement the robotic skill in the environment.

2. The method of claim 1, wherein the natural language description of the robotic skill includes a skill action descriptor and a skill object descriptor.

3. The method of claim 2, further comprising:
identifying a given region of interest, of the regions of interest, based on comparing a skill object descriptor embedding, for the skill object descriptor, to the region embedding for the given region of interest;
in response to identifying the given region of interest, using the estimated location of the region of interest in causing the robot to implement the robotic skill in the environment.

4. The method of claim 3, wherein the robotic skill is a navigation skill and wherein using the estimated location of the region of interest in causing the robot to implement the robotic skill in the environment comprises:
causing the robot to navigate to a particular location that is determined based on the estimated location.

5. The method of claim 3, further comprising:
identifying an additional given region of interest, of the regions of interest, based on comparing the skill object descriptor embedding, for the skill object descriptor, to the region embedding for the additional given region of interest;
determining, based on the estimated location of the region of interest and the estimated location of the additional region of interest, that the region of interest and the additional region of interest correspond to a same object; and
in response to determining that the region of interest and the additional region of interest correspond to the same object, using the estimated location of the region of interest and the estimated location of the additional region of interest in causing the robot to implement the robotic skill in the environment.

6. The method of claim 5, wherein the robotic skill is a navigation skill and wherein using the estimated location of the region of interest and the estimated location of the additional region of interest in causing the robot to implement the robotic skill in the environment comprises:
determining a particular location as a function of the estimated location of the region of interest the estimated location of the additional region of interest; and
causing the robot to navigate to the particular location.

7. The method of claim 5, wherein determining that the region of interest and the additional region of interest correspond to the same object is further based on comparing a first size, of the first region of interest, to a second size, of the second region of interest.

8. The method of claim 3, wherein the skill object descriptor conforms to one of the object descriptors of the subset.

9. The method of claim 1, wherein processing the vision data instances to identify the regions of interest in the environment and to determine, for each of the regions of interest, the estimated location and the region embedding comprises:
for a given vision data instance of the vision data instances:
processing the given vision data instance, using a class-agnostic object detection model, to identify a given region of interest in the vision data instance;
determining, based on the given region of interest and a pose of a vision component when the given vision data instance was captured, the estimated location for the given region of interest; and
generating the region embedding, for the given region of interest, based on processing a portion, of the given vision data instance, that corresponds to the given region of interest, wherein processing the portion is using a visual language model (VLM) encoder trained for predicting natural language descriptions of images.

10. The method of claim 1, further comprising, responsive to determining to implement the robotic skill:
processing the subset of object descriptors, the instruction, and the skill description of the robotic skill, using the LLM, to generate additional LLM output that models an additional probability distribution, over the candidate word compositions, that is dependent on the object descriptors, the instruction, and the skill description;
determining, based on the additional LLM output and an additional skill description that is an additional natural language description of an additional robotic skill performable by the robot, to implement the additional robotic skill; and
in response to determining to implement the additional robotic skill:
causing the robot to implement the additional robotic skill in the environment and after implementation of the robotic skill in the environment.

11. The method of claim 10, further comprising, responsive to determining to implement the additional robotic skill:
processing the subset of object descriptors, the instruction, the skill description of the robotic skill, and the additional skill description of the additional robotic skill, using the LLM, to generate further LLM output that models an additional probability distribution, over the candidate word compositions, that is dependent on the object descriptors, the instruction, the skill description, and the additional skill description; and
determining, based on the further LLM output, that performance of the task by the robot is complete.

12. The method of claim 1, further comprising, responsive to determining to implement the robotic skill:
processing the subset of object descriptors, the instruction, and the skill description of the robotic skill, using the LLM, to generate additional LLM output that models an additional probability distribution, over the candidate word compositions, that is dependent on the object descriptors, the instruction, and the skill description; and
determining, based on the additional LLM output, that performance of the task by the robot is complete.

13. The method of claim 1, further comprising generating the object descriptor embeddings.

14. The method of claim 13, wherein generating each of the object descriptor embeddings comprises:
processing a corresponding one of the object descriptors, using a text encoding model, to generate a corresponding one of the object descriptor embeddings.

15. The method of claim 1, wherein the object descriptors include one or more object descriptors that are not explicitly specified in the instruction.

16. The method of claim 15, wherein determining, based on the instruction, object descriptors that each describe a corresponding candidate environmental object relevant to performance of the task comprises:
processing the instruction, using the LLM or an additional LLM, to generate alternate LLM output; and
determining one or more of the object descriptors based on the alternate LLM output.

17. The method of claim 16, further comprising:
determining, based on the alternate LLM output, a category descriptor of a category; and
determining given descriptors, of the object descriptors, based on the given descriptors being descriptors of specific objects that are members of the category and based on the category descriptor being determined based on the alternate LLM output.

18. The method of claim 16, further comprising:
identifying a category descriptor, of a category, that is present in the instruction; and
determining given descriptors, of the object descriptors, based on the given descriptors being descriptors of specific objects that are members of the category and based on the category descriptor being present in the instruction.

19. The method of claim 1, wherein determining, based on the LLM output and the skill description that is the natural language description of the robotic skill, to implement the robotic skill, comprises:
determining that the probability distribution, of the LLM output, indicates the skill description with a probability that satisfies a threshold degree of probability and that the probability is greater than other probabilities determined for other candidate skill descriptions of other candidate robotic skills performable by the robot.

20. (canceled)

21. (canceled)

22. A method, comprising:
generating, based on processing vision data instances that were captured throughout an environment of one or more robots: regions of interest and, for each of the regions of interest, an estimated map location and a corresponding region embedding;
receiving a free form (FF) natural language (NL) instruction that is provided via one or more user interface input devices and that instructs a robot to perform a task;
determining, based on the FF NL instruction and the region embeddings for the regions of interest, object descriptors that each describe objects that are relevant to performing the task and that are likely present in the environment; and
utilizing the determined object descriptors in determining robotic skills for at least one of the robot(s) to implement in performing the task.

23. (canceled)

24. (canceled)

25. (canceled)

26. (canceled)

27. (canceled)

28. A method implemented by one or more processors, the method comprising:
capturing, using one or more vision components, vision data instances throughout an environment of at least one robot;
for each the vision data instances:
processing the vision data instance, using a class-agnostic object detection model, to identify any regions of interest in the vision data instance;
for each of a plurality of regions of interest identified from the vision data instances:
determining an estimated location of the region of interest;
generating, based on processing vision data, from a corresponding one of the vision data instances and that corresponds to the region of interest, a region embedding for the region of interest, wherein generating the region embedding comprises processing the vision data using a visual language model encoder trained for predicting natural language descriptions of images; and
generating an entry that associates the estimated location with the region embedding;
subsequent to generating the entries:
identifying an instruction for a robot to perform a task, the instruction being a free-form natural language instruction generated based on user interface input that is provided by a user via one or more user interface input devices;
determining, based on the instruction, one or more object descriptors that each describe a corresponding object relevant to performance of the task;
processing each of the one or more object descriptors, using a text encoding model, to generate a corresponding object descriptor embedding;
comparing the object descriptor embeddings, to the region embeddings of the entries, to identify a subset of the object descriptor embeddings that each correspond to at least one of the entries;
responsive to identifying the subset of object descriptors, processing the subset of object descriptors and the instruction, using a large language model (LLM), to generate LLM output that models a probability distribution, over candidate word compositions, that is dependent on the object descriptors and on the instruction;
determining, based on the LLM output and a skill description that is a natural language description of a robotic skill performable by the robot, to implement the robotic skill; and
in response to determining to implement the robotic skill:
causing the robot to implement the robotic skill in the environment.

29. (canceled)

30. (canceled)

31. (canceled)
